(19) United States
(12) Patent Application Publication
(10) Pub. No.: US 2017/0150529 A1
(43) Pub. Date: May 25, 2017

(54) Method, Device and System for Reporting and Receiving Trunked Service Attribute

(71) Applicant: Beijing Xinwei Telecom Technology Inc., Beijing (CN)

(72) Inventors: Yuanchun TAN, Beijing (CN); Wenzhong ZHANG, Beijing (CN); Wei ZHENG, Beijing (CN); Qihua HUANG, Beijing (CN); Ruifeng XU, Beijing (CN)

(21) Appl. No.: 15/309,484

(22) PCT Filed: Dec. 22, 2014
(86) PCT No.: PCT/CN2014/094477

§ 371 Date: Nov. 8, 2016

(30) Foreign Application Priority Data
Dec. 23, 2013 (CN) 201310716929.X

(51) Int. Cl. H04W 74/08; H04W 72/12; H04W 76/02; H04W 76/04; H04W 4/06; H04W 24/08

(52) U.S. Cl. CPC H04W 74/0833; H04W 4/06; H04W 24/08; H04W 76/027; H04W 76/028; H04W 76/046; H04W 72/12; H04W 88/08

(57) ABSTRACT

The present disclosure provides a method for reporting a trunked service attribute. The method includes: when a trunked terminal is to report the trunked service attribute, the trunked terminal reports the trunked service attribute to a base station via the third message MSG3 during a contention based random access procedure or via the first uplink data/signaling packet after obtaining the trunked service attribute. Based on the same concept, the present disclosure also provides a method of receiving a trunked service attribute, and a corresponding trunked terminal, a corresponding base stations and a corresponding system.

### TECHNICAL FIELD

The present disclosure relates to trunked communications, and more particularly, to a method, a device and a system for reporting and receiving a trunked service attribute.

### BACKGROUND

In a trunked radio communication system, for a specific group call, a base station does not know which terminal in its cell is going to receive the group call. That is, the base station does not know whether a terminal in its cell is going to receive the group call. One solution to this problem is to allow the base station to acquire relevant information from the network side. For example, the base station may acquire information from the network side about whether a User Equipment (UE) to be scheduled by an individual service belongs to a group call or not. Another solution to this problem is to allow the base station to acquire the information of all the UEs of the group call from the network side, and monitor any UE to be scheduled by an individual service in the cell and then determine whether the UE to be scheduled belongs to the group call or not.

### SUMMARY

To solve the problem above, according to one aspect of the present disclosure, a method for reporting a trunked service attribute is proposed. The method includes: reporting, by a trunked terminal, the trunked service attribute to a base station via the third message MSG3 during a contention based random access procedure, when the trunked terminal is to report the trunked service attribute.

According to another aspect of the present disclosure, a method for receiving a trunked service attribute is also proposed. The method includes: receiving, by a base station, a trunked service attribute reported by a trunked terminal via the third message MSG3 during a contention based random access procedure of the trunked terminal.

According to still another aspect of the present disclosure, a trunked terminal to achieve the method above is proposed. The trunked terminal includes: a reporting module, to report to a base station a trunked service attribute through the third message MSG3 during a contention based random access procedure, when the trunked terminal is to report the trunked service attribute.

According to yet another aspect of the present disclosure, a base station to achieve the method above is proposed. The base station includes: a receiving module, to receive a trunked service attribute reported by a trunked terminal via the third message MSG3 during a contention based random access procedure of the trunked terminal.

Finally, the present disclosure also provides a system for processing a trunked service attribute, including a trunked terminal and a base station described above.

### BRIEF DESCRIPTION OF THE DRAWINGS

In order to illustrate technical schemes in the present disclosure or existing technology more clearly, the attached drawings used in the examples will be introduced simply. Apparently, the drawings in the following description are only some examples of the present disclosure, to those ordinary skilled persons, without creative efforts, they can also obtain other drawings based on these drawings.

FIG. 1 is a basic flowchart of reporting and receiving a trunked service attribute proposed by the present disclosure;

FIG. 2 is a flowchart of a contention based random access procedure in an LTE system;

FIG. 3 is a flowchart of a non-contention based random access procedure in an LTE system;

FIG. 4 shows an LCID list of an UL-SCH channel in an LTE system;

FIG. 5 shows an LCID list containing customized G-RNTI;

FIG. 6 show the structure of a G-RNTI MAC CE;

FIG. 7 is a flowchart of an initial random access procedure;

FIG. 8 is a flowchart of a non-competition based random access during a handover;

FIG. 9 is a flowchart of a contention based random access procedure triggered by uplink data arrival;

FIG. 10 is a block diagram illustrating the structure of a trunked terminal according to examples of the present disclosure;

FIG. 11 is a block diagram illustrating the structure of a base station according to examples of the present disclosure;

FIG. 12 is a block diagram illustrating the structure of a system according to examples of the present disclosure;

FIG. 13 is a block diagram illustrating the hardware structure of a trunked terminal according to examples of the present disclosure; and

FIG. 14 is a block diagram illustrating the hardware structure of a base station according to examples of the present disclosure.

### DETAILED DESCRIPTIONS

It was found that by the conventional method the base station may know the group call service attributes, but the implementation of the conventional method will increase the complexity and maintaining difficulty of the processing of the network-side device. Thus, a technical scheme of trunked service attributes processing is proposed to interpret the problem mentioned above from another point of view without increasing the complexity of the network side.

In order to make the objects, technical solutions and advantages of the present disclosure more clearly, the attached figures used in the implementation examples will be introduced clearly and completely, apparently, the drawings in the following description are only some examples of the present disclosure, but not all the embodiments. It should be noted that, in the case of no conflict, examples of the present disclosure and the technical features of the examples can be arbitrarily combined with each other. Based on the examples of the present disclosure, other examples acquired by those skilled in the art without making any creative work belongs to the protection range of the present disclosure.

The flowchart of a method for reporting and receiving a trunked service attribute proposed by the present disclosure is shown in FIG. 1. The method includes two parts: a terminal-side part and a base-station side part.

On the terminal side:

In block 101, a trunked terminal determines whether there is any trunked service attribute to be reported.

In block 102, when there is a trunked service attribute to be reported, the trunked terminal reports the trunked service attribute to a base station through the third message MSG3 during a contention based random access procedure, shown as a block with solid line in FIG. 1. Wherein, under the following circumstances the trunked terminal needs to report the trunked service attribute: when the trunked terminal has subscribed a called service of a group call or when the called service of the group call subscribed by the trunked terminal changes.

Wherein, when the trunked terminal is in a Radio Resource Control idle (RRC_Idle) state and has subscribed a called service of a group call, the trunked terminal may report the trunked service attribute to the base station.

The contention based random access procedure may be a random access procedure during re-establishment. The triggers of the random access procedure during re-establishment may include: a radio link failure, a handover failure, a failure of integrity protect or a failure of RRC connection reconfiguration.

The contention based random access may also be a random access triggered by uplink (UL) data arrival. The triggers of the random access triggered by the UL data arrival may include: out of synchronization in uplink or in absence of scheduling request resources.

In block 103, the trunked terminal can also report the trunked service attribute to the base station through a first uplink data/signaling packet after obtaining the trunked service attribute, shown as a block with dotted line in FIG. 1.

When the trunked terminal hands over to a target cell, the trunked terminal may report the trunked service attribute to the base station after the trunked terminal receives the trunked service attribute of the called service of the group call in the target cell. In this case, the trunked service attribute can be reported through the MSG3 during the contention based random access procedure or through the first uplink data/signaling packet after obtaining the trunked service attribute.

Specifically, the trunked terminal may report the trunked service attribute to the base station through a Media Acess Control Control Element (MAC CE) in the MSG3 or an MAC CE in the first uplink data/signaling packet.

In the method described above, the trunked service attribute may include but not limited to a Group Radio Network Temporary Identifier (G-RNTI). In this case, the MAC CE may be a G-RNTI MAC CE.

On the base station side:

In block 104, the base station may receive the trunked service attribute reported by the trunked terminal through the MSG3 during the contention based random access procedure, as shown in a block with solid line of FIG. 1.

In block 105, the base station may alternatively receive the trunked service attribute reported by the trunked terminal through the first uplink data/signaling packet, as shown in a block with dotted line of FIG. 1.

Specifically, the base station may receive an MAC CE in the MSG3 or an MAC CE in the uplink data/signaling packet, and obtain the trunked service attribute reported by the trunked terminal from the MAC CE received. Wherein, the trunked service attribute may include, but not limited to a G-RNTI. In this case, the MAC CE may be a G-RNTI MAC CE.

The specific implementations of the present disclosure will be described in detail in the following description by taking an LTE system as an example.

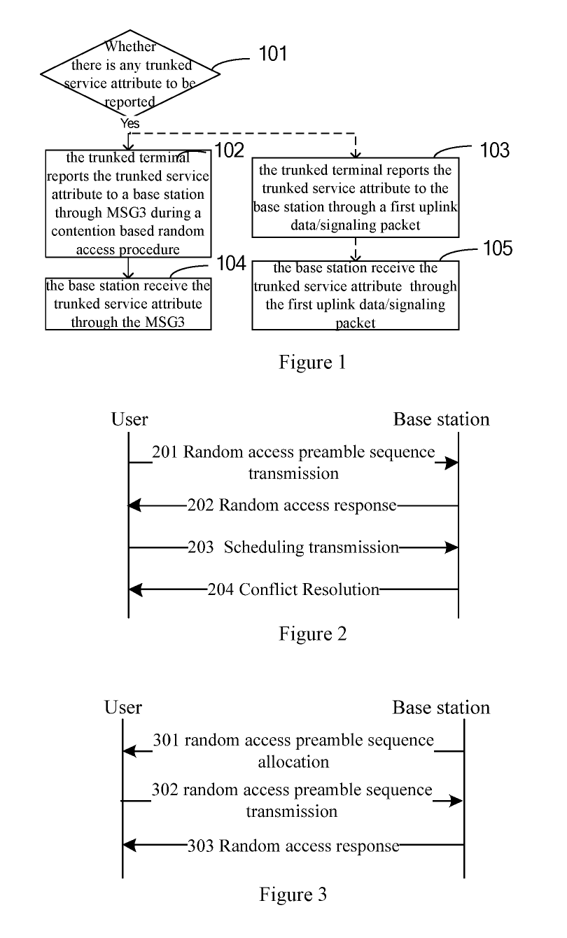

According to the specification of “3GPP TS 36.300 V11.7.0”, a random access procedure may take two distinct forms: contention based random access procedure (as shown in FIG. 2) or non-contention based random access procedure (as shown in FIG. 3). And there are six events that may trigger a random access procedure, which include: initial random access, RRC Connection Re-establishment procedure, handover, downlink (DL) data arrival during RRC_Connected, UL data arrival during RRC_Connected and for positioning purpose during RRC_Connected. Wherein, the first five events support the contention based random access procedure. While the following events: DL data arrival during RRC_Connected, handover and for positioning purpose during RRC_Connected support the non-contention based random access procedure.

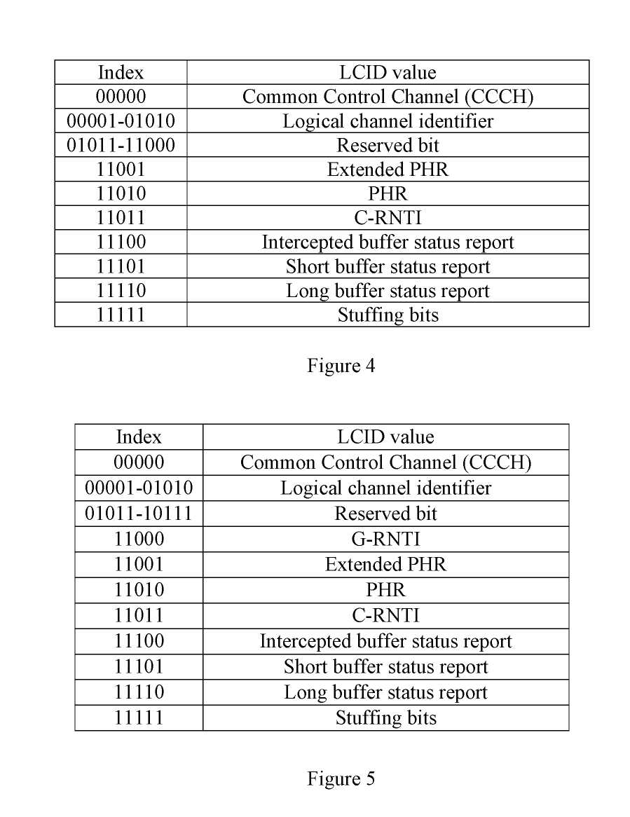

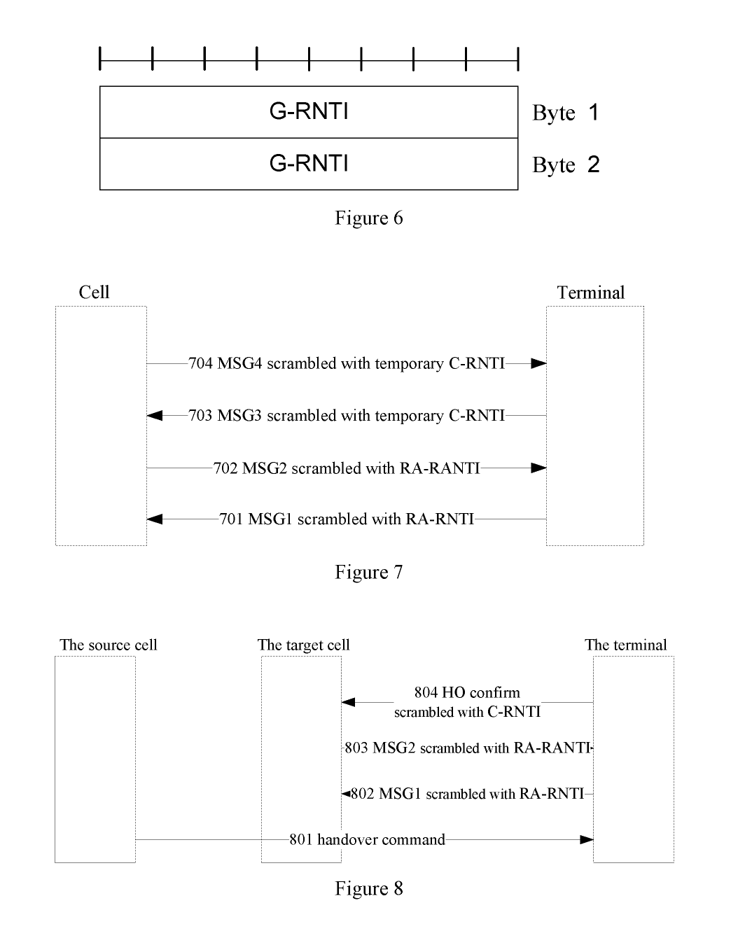

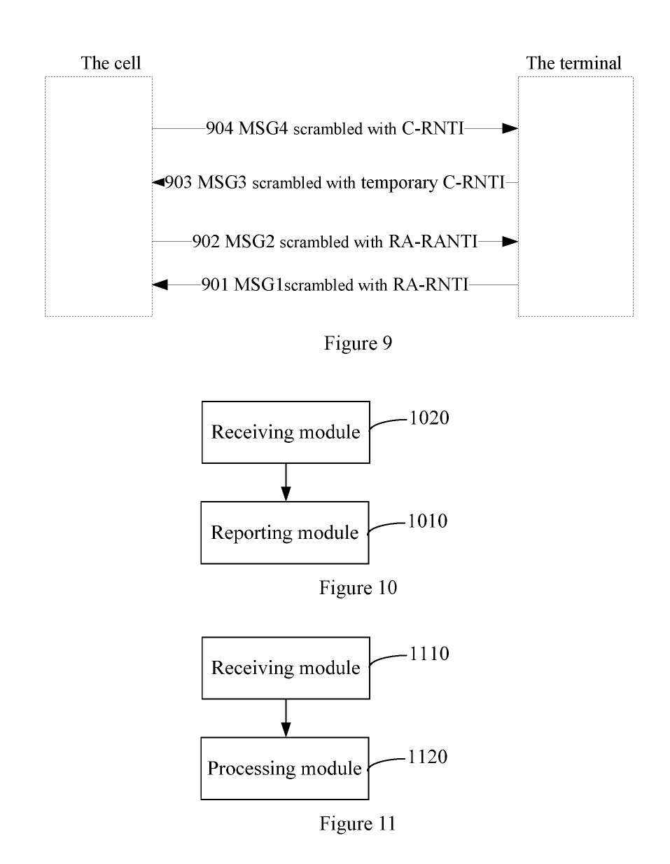

According to the specification of “3GPP TS 36.321 V11.3.0”, logical channel identifiers (LCID) of an Uplink Shared Channel (UL-SCH) in LTE are shown in FIG. 4. FIG. 5 illustrates an LCID list containing customized G-RNTI. In FIG. 5, the index corresponding to the LCID of the G-RNTI is defined as 11000. Of course, this index may be defined as another figure. The length of a G-RNTI MAC CE is fixed, which may be 16-bit long. The G-RNTI MAC CE stores the G-RNTI of the called service of the group call of the terminal. The structure of the G-RNTI MAC CE is shown in FIG. 6.

In each of the following examples, it assumes that the terminal uses the G-RNTI MAC CE shown in FIG. 6 to report the trunked service attributes.

In a first example, the attribute is reported during an initial contention based random access procedure.

Firstly, the initial random access procedure in LTE is introduced, which is shown in FIG. 7.

The initial random access procedure is described as follows:

In step 701, a UE initiates the first message MSG1. Wherein, the MSG1 is scrambled with a Random Access Cell Radio Network Temporary Identifier (RA-RNTI), and the RRC state of the UE is RRC Idle.

In step 702, the base station receives the MSG1 and issues the second message MSG2, which carries a temporary Cell Radio Network Temporary Identifier (temporary C-RNTI). Wherein, the MSG2 is scrambled with the RA-RNTI.

In step 703, the UE receives the MSG2, and obtains the temporary C-RNTI. Then the UE sends the third message MSG3. Wherein, the MSG3 is scrambled with the temporary C-RNTI, and the RRC state of the UE is RRC_Idle.

In step 704, the base station receives the MSG3 and establishes a UE entity using a C-RNTI for the UE. Wherein, the value of the C-RNTI is the same as that of the temporary C-RNTI. Then the base station issues an MSG4 which is scrambled with the temporary C-RNTI.

The base station may then communicate with the UE using the corresponding UE entity.

The terminal receives the fourth message MSG4, sets the value of the C-RNTI as the temporary C-RNTI, and switches the RRC state from RRC_Idle to RRC_Connected.

In this example, it is assumed that the base station is in Cell0. Cell0 has the trunked group call service, whose G-RNTI is 10. There is a trunked terminal UE0 in the cell. UE0 is in RRC_Idle state and receives the trunked group call service. When Cell0 on the base station side and UE0 on the terminal side initiate an initial random access procedure, UE0 and Cell0 may perform the following procedure:

On the terminal UE0 side:

UE0 informs the base station the G-RNTI through a G-RNTI MAC CE in an MSG3. Wherein, UE0 uses the temporary C-RNTI distributed by the base station to scramble the MSG3.

On the base station side in Cell0:

The base station in Cell0 obtains the G-RNTI (which is 10) from the G-RNTI MAC CE in the MSG3 by using the temporary C-RNTI (which is 12) to descramble the MSG3. Then the base station in Cell0 knows that the terminal corresponding to the temporary C-RNTI has subscribed a called service of a group call whose G-RNTI is 10.

Specifically, the base station may establish an entity corresponding to UE0 using the C-RNTI, after receiving the MSG3. Wherein the value of the C-RNTI is the same as that of the temporary C-RNTI, which is 12. The base station then knows that UE0 whose C-RNTI is 12 has subscribed a called service of a group call whose G-RNTI is 10.

In a second example, the attribute is reported during a handover to a target base station of a trunked terminal.

Firstly, the handover procedure under the non-contention based random access procedure is introduced, which is shown in FIG. 8.

In step 801, a source cell sends a handover command (HO Command) to the terminal, which contains information such as a dedicated preamble and a C-RNTI corresponding to the terminal in a target cell.

In step 802, after receiving the HO Command sent by the source cell, the terminal obtains the dedicated preamble, the C-RNTI and other information in the HO Command. The terminal then initiates an MSG1 to the target cell using the dedicated preamble.

In step 803, the target cell receives the MSG1 and issues an MSG2, which carries a temporary C-RNTI (whose value could be the same as the value of the C-RNTI in the HO Command). Wherein, the MSG2 is scrambled by an RA-RNTI.

In step 804, the UE receives the MSG2; and sends a handover confirmation (HO Confirm) according to an uplink grant in the MSG2. Wherein, the HO Confirm is scrambled by the C-RNTI.

In the present example, it is assumed that Cell0 and Cell1 are two cells on the base station side, and trunked group call services are both present in Cell0 and Cell1. The G-RNTI of the trunked group call service in Cell0 is 100, and the G-RNTI of the trunked group call service in Cell1 is 150. There is a trunked terminal UE0 in one of the cells, which is in RRC_Idle state and receives the trunked group call service. When a handover procedure of UE0 between Cell0 and Cell1 occurs, a non-contention based random access procedure is carried out.

On the terminal UE0 side:

After receiving the attribute G-RNTI of the trunked group call of the target cell Cell1, the terminal UE0 informs the base station the G-RNTI through a G-RNTI MAC CE in the first uplink packet.

Specifically, based on the non-contention random access procedure as shown in FIG. 8, UE0 informs the base station the G-RNTI through a G-RNTI MAC CE in the HO confirm in step 804. Wherein the HO confirm is scrambled with the C-RNTI (which is 12).

On the base station side in Cell1

The base station in Cell1 receives the G-RNTI MAC CE in the first uplink packet from the terminal UE0 by descrambling the packet with C-RNTI (which is 12), and obtains the G-RNTI, which is 150. Then the base station may know that UE0 has subscribed a called service of a group call whose G-RNTI is 150.

Of course, in this example, the terminal can also report the attribute through an MSG3 during the contention based random access procedure. The base station then may receive the attribute accordingly.

In a third example, the attributes are reported during a random access procedure triggered by UL data arrival.

Firstly, the procedure of a random access triggered by UL data arrival is introduced.

In step 901, a UE initiates an MSG1. Wherein, the MSG1 is scrambled with an RA-RNTI.

In step 902, the base station receives the MSG1, and issues an MSG2 carrying a temporary C-RNTI. Wherein, the MSG2 is scrambled with the RA-RNTI.

In step 903, the UE receives the MSG2, obtains the temporary C-RNTI, and transmits an MSG3. Wherein, the MSG3 is scrambled with the temporary C-RNTI.

In step 904, the base station receives the MSG3, obtains the C-RNTI in the C-RNTI MAC CE of the MSG3, which is assumed to be C, finds out the UE entity whose C-RNTI is equal to C from the UE entities reserved in the base station, and then sends an MSG4. Wherein, the MSG4 is scrambled with the C-RNTI.

Finally, the terminal receives the MSG4.

In this example, it is assumed that the base station is in Cell0, and there are trunked group call services in Cell0, whose G-RNTI is 22. There is a trunked terminal UE0 in the cell. UE0 is in RRC_Connected state and receives the trunked group call service. The C-RNTI of UE0 is 33. When UL data arrive, Cell0 and UEO may perform a random access procedure.

On the terminal UE0 side

UE0 informs the base station the G-RNTI (which is 22) through a G-RNTI MAC CE in an MSG3, MSG3 may also contain a C-RNTI MAC CE carrying the C-RNTI (which is 33) of UE0. UE0 uses a temporary C-RNTI (which is 35) distributed by the base station to scramble the MSG3.

On the base station side in Cell0

The base station in Cell0 receives the MSG3, descrambles the MSG3 with the temporary C-RNTI (which is 35), obtains the C-RNTI from the C-RNTI MAC CE of the MSG3, which is 33; obtains the G-RNTI from the G-RNTI MAC CE of the MSG3, which is 22. Then the base station may know that the terminal corresponding to a UE entity whose C-RNTI is 33 has subscribed a called service of a group call whose G-RNTI is 22.

In a fourth example, the attributes are reported while the trunked service changes.

It is assumed that the base station is in Cell0, and there are trunked group call service in Cell0, whose G-RNTI is 22, There is a trunked terminal UE0 in the cell. UE0 is in the RRC_Connected state and receives the trunked group call service. The C-RNTI of UE0 is 33.

The base station in Cell0 establishes a new trunked group call service with the G-RNTI being equal to 56. And UE0 also belongs to this trunked group call. And the trunked group call service whose G-RNTI is 56 has a higher priority than the trunked group call service whose G-RNTI is 22.

UE0 receives a paging message from the trunked group call service with the G-RNTI being 56, and determines that the group call service with the G-RNTI being 56 4 has a higher priority than the group call service with the G-RNTI being 22, And after entering the trunked group call service with the G-RNTI being 56, the terminal may report that the G-RNTI is 56 to the base station in Cell0 through a G-RNTI MAC CE.

Based on the same concept, the present disclosure also provides a trunked terminal to achieve the method described above. As shown in FIG. 10, the terminal includes a reporting module 1010, to report the trunked service attributes to the base station via an MSG3 in a contention based random access procedure when there is a trunked service attribute to be reported.

In some examples, when the trunked terminal is in RRC_Idle state and has subscribed a called service of a group call, the reporting module may report the trunked service attribute to the base station.

In some examples, the contention based random access is a random access during re-establishment. The triggers of the random access during re-establishment may include: a radio link failure, a handover failure, or a failure to protect the integrity or of a failure of connection reconfiguration of the RRC.

In some examples, the contention based random access is a random access triggered by UL data arrival. The triggers of the random access triggered by UL data arrival may include: out of synchronization in uplink or in absence of scheduling request resources.

In some examples, the reporting module reports the trunked service attribute to the base station through the first uplink data/signaling packet after obtaining the trunked service attribute.

In some examples, the trunked terminal also includes a receiving module 1020, to receive the trunked service attribute of the called service of the group call in a target cell when the trunked terminal handovers to the target cell. In this case, the reporting module reports the trunked service attribute received by the receiving module to the base station.

In some examples, the trunked terminal reports the trunked service attribute to the base station through an MAC CE in an MSG3 or an MAC CE in the first uplink data/signaling packet.

In some examples, the trunked service attribute includes, but not limited to, a G-RNTI. In this case, the MAC CE is a G-RNTI MAC CE.

Under the following cases, the trunked terminal would report the trunked service attribute: when the trunked terminal has subscribed a called service of a group call or when the called service of a group call subscribed changes.

Based on the same concept, the present disclosure also provides a base station to achieve the method above. The base station includes a receiving module 1110, to receive a trunked service attribute reported by a trunked terminal through an MSG3 during a contention based random access procedure.

The receiving module is further to receive a trunked service attribute reported by the trunked terminal through an uplink data/signaling packet.

The base station also includes a processing module 1120, to obtain the trunked service attribute reported by the trunked terminal from the MAC CE of the MSG3 or the uplink data/signaling packet received.

In some examples, the trunked service attribute includes, but not limited to, a G-RNTI. In this case, the MAC CE is a G-RNTI MAC CE.

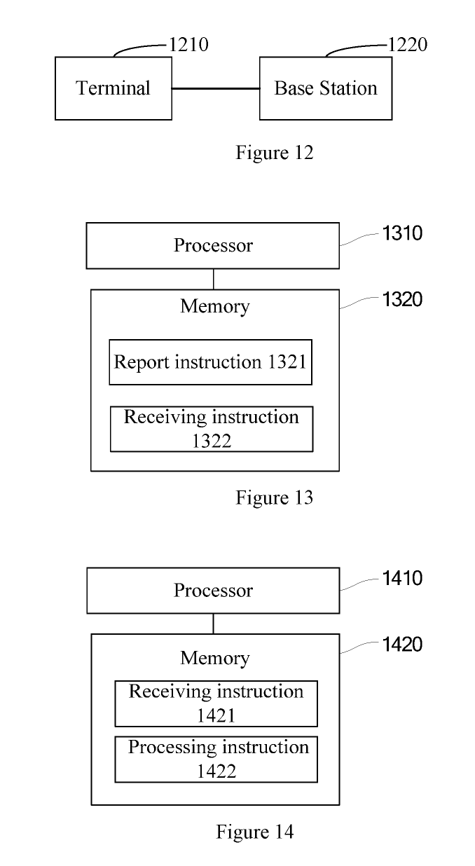

Based on the same concept, the present disclosure also provides a system processing a trunked service attribute. As shown in FIG. 12, the system includes a terminal 1210 and a base station 1220 described above.

FIG. 13 shows a hardware schematic diagram of a terminal which can report a trunked service attribute according to some examples of the disclosure. As shown in FIG. 13, the terminal includes one or more processors 1310, a memory 1320, and one or more program instructions stored in the memory 1320 and executed by the one or more processors 1310. For example, the one or more program instructions may include instructions performed in each step of the method above, which include a report instruction 1321 and a receiving instructions 1322. Detailed implementations of these instructions may be found in the descriptions of the methods performed by the terminal and also in the descriptions of the structure of the terminal.

FIG. 14 shows a hardware schematic diagram of a base station which can receive a trunked service attribute according to some examples in the disclosure. As shown in FIG. 14, the base station includes one or more processors 1410, a memory 1420, and one or more program instructions stored in the memory 1420 and executed by the one or more processors 1410. For example, the one or more program instructions include instructions performed in each step of the method above, which include a receiving instruction 1421 and a processing instruction 1422. Detailed implementations of these instructions may be found in the descriptions of method performed by the base station and also in the descriptions of the structure of the base station.

From the specific instructions above, it can be seen, the present disclosure can learn whether the terminal in the cell has subscribed a called service of a group call or not, without increasing radio signaling on the base station side. The present disclosure provides a good solution to the problem that the base station does not know which terminal will receive the group call in this cell.

Those ordinary skilled staff in the field will appreciate that: achieving all or part steps of the method above may be completed by the hardware related to program instructing, the program may be stored in readable storage medium of a computer, when the program executes, the steps of the method embodiments above is executed; and the storage medium includes: ROM, RAM, disk, or CD and the other mediums that can store program codes.

Finally, it should be noted that: The above embodiments are merely used to describe the technical solutions of the present disclosure, but not intended to limit it; although reference to the embodiments the present invention has been described in detail, ordinary skill staff in the field will appreciate: they can still modify the technical solutions above described in the embodiments, or replace some technical features equivalently; and such modifications or replacements do not make the essence of corresponding technical solutions depart from the spirit and scope of the technical program of embodiments in the present disclosure.

The embodiments above are merely part of the embodiments of the present disclosure, but not all the embodiments. Under the premise that those ordinary skill staff do not make creative work, any modification, equivalent replacements or improvements within the spirit and principles of the present disclosure, shall fall within the protection range of the present disclosure.

1. A method for reporting a trunked service attribute, comprising:
reporting, by a trunked terminal, the trunked service attribute to a base station via the third massage MSG3 during a contention based random access procedure, when the trunked terminal is to report the trunked service attribute.

2. The method according to claim 1, wherein, the trunked terminal is to report the trunked service attribute when the trunked terminal has subscribed a called service of a group call or when the called service of the group call changes.

3. The method according to claim 1, wherein, the trunked terminal is to report the trunked service attribute when the trunked terminal is in RRC_idle state and has subscribed the called service of the group call.

4. The method according to claim 1, wherein, the contention based random access is a random access during re-establishment.

5. The method according to claim 4, wherein, the triggers of the random access during re-establishment comprise: a radio link failure, a handover failure, a failure of protecting the integrity or a failure of connection reconfiguration of the RRC.

6. The method according to claim 1, wherein, the contention based random access is a random access triggered by uplink data arrival.

7. The method according to claim 6, wherein, the triggers of random access triggered by uplink data arrival comprise: out of synchronization in uplink or in absence of scheduling request resources.

8. The method according to claim 1, further comprising:
reporting, by the trunked terminal, the trunked service attribute to the base station through the first uplink data/signaling packet after obtaining the trunked service attribute.

9. The method according to claim 8, wherein, the trunked terminal is to report the trunked service attribute when the trunked terminal has subscribed a called service of a group call or when the called service of the group call changes.

10. The method according to claim 8, wherein, the trunked terminal is to report the trunked service attribute when the trunked terminal handovers to a target cell, and receives the trunked service attribute of the called service of the group call in the target cell.

11. The method according to claim 8, wherein, the trunked terminal reports the trunked service attribute to the base station through a Media Access Control Control Element MAC CE of the MSG3 or of the first uplink data/signaling packet.

12. The method according to claim 1, wherein, the trunked service attribute comprises a Group Radio Network Temporary Identifier G-RNTI.

13. The method according to claim 12, wherein, the MAC CE is a G-RNTI MAC CE.

14. A method for receiving a trunked service attribute, comprising:
receiving, by a base station, a trunked service attribute reported by a trunked terminal via the third message MSG3 during a contention based random access procedure of the trunked terminal.

15. The method according to claim 14, further comprising:
receiving, by the base station. The trunked service attribute reported by the trunked terminal through the first uplink data/signaling packet.

16. The method according to claim 14, wherein, receiving the service attribute comprises: receiving, by the base station, a Media Access Control Control Element MAC CE in the MSG3 or in the uplink data/signaling packet and obtaining the trunked service attribute from the MAC CE.

17. The method according to claim 14, wherein, the trunked service attribute comprises a Group Radio Network Temporary Identifier G-RNTI.

18. The method according to claim 17, wherein, the MAC CE is a G-RNTI MAC CE.

19. A trunked terminal, comprising:
one or more processors;
a memory; and
one or more program instructions stored in the memory and executed by the one or more processors; wherein
the one or more program instructions comprises:
a reporting module, to report to a base station a trunked service attribute through the third message MSG3 during a contention based random access procedure, when the trunked terminal is to report the trunked service attribute.

20-27. (canceled)

28. The trunked terminal according to claim 19, wherein the one or more program instructions comprises:
a receiving module, to report the trunked service attribute when the trunked terminal handovers to a target cell, and receives the trunked service attribute of the called service of the group call in the target cell; and
the reporting module is to report the trunked service attribute received by the receiving module to the base station.

29-31. (canceled)

32. A base station, comprising:
one or more processors;
a memory; and
one or more program instructions stored in the memory and executed by the one or more processors; wherein
the one or more program instructions comprises:
a receiving module, to receive a trunked service attribute reported by a trunked terminal via the third message MSG3 during a contention based random access procedure of the trunked terminal.

33. (canceled)

34. The base station according to claim 32, wherein the one or more program instructions comprises:
a processing module, to receive a Media Access Control Control Element MAC CE in the MSG3 or in an uplink data/signaling packet and obtain the trunked service attribute from the MAC CE.

35-37. (canceled)
